(19) United States
(12) Patent Application Publication
(10) Pub. No.: US 2006/0008241 A1
(43) Pub. Date: Jan. 12, 2006

(54) Apparatus for retrieving media information from stackable optical driver

(75) Inventors: Hong-Chi Chen, Fon-Shen City (TW); Jung-Chou Kao, Hsin-Chu City (TW); Wei-Chen Chih, Hu-Ko Town (TW); Jou-Wei Fu, Hsin-Chu City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: MUSTEK SYSTEMS INC.

(21) Appl. No.: 10/886,562

(22) Filed: Jul. 9, 2004

(51) Int. Cl. H04N 5/76

(52) U.S. Cl. 386/46; 386/125

(57) ABSTRACT

A stackable optical driver includes an optical reading device, a playing platform, a stackable box and an encoding/decoding module. The stackable optical driver is a modulized design by enhancing a media playing 10 platform with stackable various functions, such as CD-ROM, CD-RW, DVD-ROM, DVD-RW, DVD-Dual and digital camcorder, home gateway, media database and so on. When the reading device of the optical drive malfunctions, only that malfunctioned reading device needs to be changed.

### BACKGROUND OF THE INVENTION

1. Field of the Invention

The present invention relates a platform of stackable media player. By a modulized design, the goal to play the different format optical data or media data can be reached by only stacking different reading devices.

2. Background Description

The prosperous development of digit content and information has brought the human being into the colorful media era. The digital content's multi-media data such as music, video, pictures, games and digital database etc. mostly requires a significant storage space; thus, it leads the fast development of the mass storage device. Although the fast development of the mass storage device provides the users a great convenience about the storage device; however, upon the varied storage formats, encoding ways, and read/write techniques, the different devices are with the different specifications. This causes a great inconvenience about the interflow of data; moreover, when the user is choosing the playing device, the user has to pick among those with the different specifications; then the one has been chosen is usually able to read the CD of single one format or of limited formats. Assume to read the CD or the storage device of another specification, it requires to use another playing device; it causes a great inconvenience use-wise. Additionally, for two different CD playing devices, besides the different read/write mechanisms, many of the rest components are duplicated. It also leads into the waste of resource. Therefore, the present invention offers a modulized design for the users who only need to switch the corresponding module and stack on the data playing platform in order to read the varied CDs or data storage formats, further to meet the advantages of economy, flexibility and upgradeability.

Traditionally, the known CD playing platform is able to read and play one CD format. Its benefits are low cost and easy application. However, being able to read only one CD format causes the limitation. In other words, it requires another player to read and write the optical compact disk, such as DVD or other format, and it's the significant waste of resource as well.

In order to improve the drawback of the playing platform as above, another known media player adopts the multi-function read/write device to read and play the CD with the various formats. Because of the expensive multi-function read/write device, it leads the high price of such player. Besides, what can play on such player is still limited, some specific players are still required for some specific formats. It's still not flexible use-wise. If the user would like to have the other format of optical compact disk being read, the user has to buy another compact disk player. Nonetheless, if the above-mentioned multi-function read/write device is broken or fails, the user seldom repairs it. Most likely, the user will buy a new one. In this case, it wastes money and resources since some common parts of the failed device are still same, workable or adoptable.

### SUMMARY OF THE INVENTION

According to the above objects and to solve the known shortcomings like the inflexibility of player's specification, multi-function and the price, the present invention offers a modulized design for the users who only switch the different reading device upon the varied needs in order to meet the objects of the flexibility and multi-function.

In another object of the present invention, it is to mitigate the complexity of the optical data reading device and further to reduce its price.

In another object of the present invention, by applying the modulized design, when the reading drive of the platform is malfunctioned or needs to be upgraded, only the reading drive needs to be replaced with another one; hence, it can save the cost from maintenance or upgrade.

According to the above objects, the present invention offers a platform of stackable media player, which includes: a data reading drive to read the data on CD; a stackable box to hold the data read/write drive; a playing platform to carry the stackable box and to connect with the data read/write drive further to play the data accessed by the data read/write drive; and an encoding/decoding module to provide the encoding/decoding programs required by the data read/write drive.

In one aspect of the present invention, the data reading drive can also be a writeable device. With the programs in the encoding/decoding module, the platform is able to encode the data within into the certain format and to write into the CD.

In another aspect of the present invention, the data reading drive can also be the read/write device for the varied data format such as CD-ROM, CD-RW, DVD-ROM, DVD-RW, DVD-Audio, SACD or HDD.

In another aspect of the present invention, the stackable boxes are piled up on the playing platform.

In another aspect of the present invention, several stackable boxes can be piled up on the playing platform in order to access data from the various sources and to simultaneously process the data further to play or to write back in.

In another aspect of the present invention, besides the way to pile up the stackable boxes and to get connected with the platform, the data reading drive also can be accessed through the common industrial transmission standards (as the interfaces of USB, IEEE 1394, IDE, SCSI, 802.3 or 802.11b) to get connected with the playing platform.

In another aspect of the present invention, in accord to the switch of the different data reading device, the encoding/decoding module can be filled in with the different one even can be copied with the different encoding/decoding programs upon requirements.

In another aspect of the present invention, a superior exemplary implementation includes: a data read/write device: to read the data stored in CD or to write in accordance with the certain format; a stackable box: to hold the data read/write device; a playing platform: to cradle the stackable box or to carry several stackable boxes and to connect with the read/write device for the access of data; an encoding/decoding module: to provide the encoding/decoding programs required by the data read/write device. Besides playing the data accessed by the read/write device, by utilizing the read/write device, the platform can also copy the data and write into the specific CD or storage media.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is the diagram of the stackable way of the present invention;

FIG. 2 is the diagram of exemplary implementation of the present invention;

FIG. 3 is the diagram of one linkage way to connect the platform with the stackable boxes; and

FIG. 4 is the diagram of another linkage way to connect the platform with the stackable boxes.

### DETAILED DESCRIPTION OF A PREFERRED EMBODIMENT OF THE INVENTION

In order to provide a clear description and better understanding, charts/diagrams are not drawn in portion and relative scale. The size of some parts is also exaggerated compared in scale to other related parts. To be more concise, irrelative details are not drawn completely.

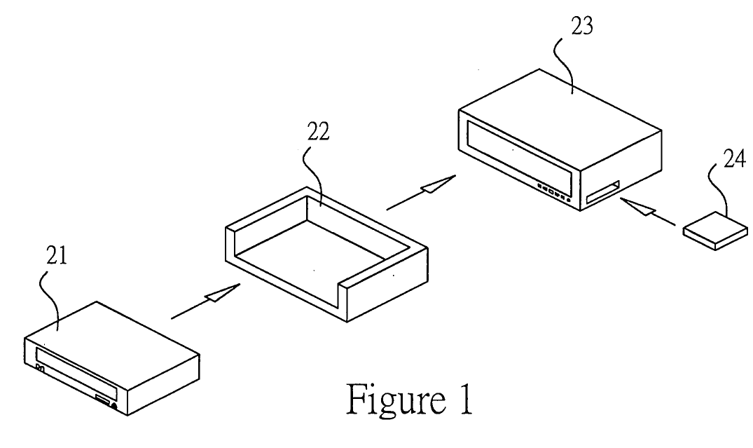

FIG. 1 is the diagram of the present invention as: a data read/write device 21 held by a stackable box 22 is piled upon a playing platform 23 and the data accessed by the data read/write device 21 is decoded by an encoding/decoding module 24 and is played by the platform 23: Besides playing the data accessed by the data read/write device 21, via the encoding/decoding module 24, the platform 23 also can encode the data into a certain data format then through the data read/write device 21 copy and write to the particular CD or the storage media.

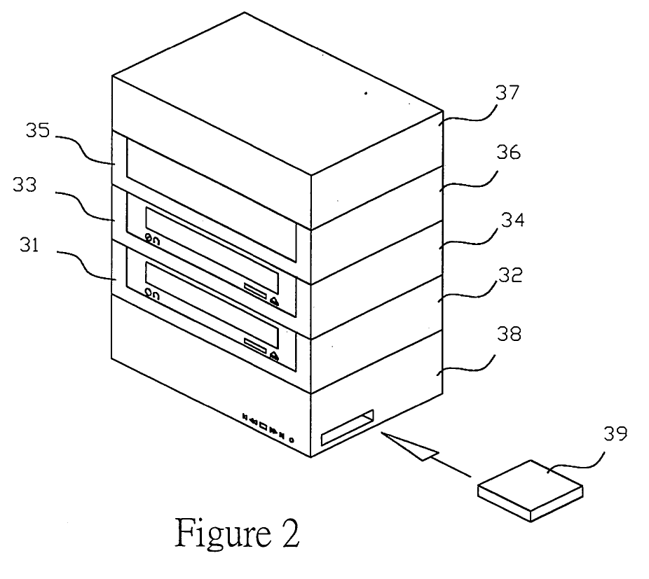

FIG. 2 is the diagram of another embodiment of the present invention, shown as a data reading device 31 held by the first stackable box 32, a data writing device 33 held by the second stackable box 34, a mass storage disc 35 held by the third stackable box 36 and a residential gateway 37 are piled upon the top a platform 38; the data accessed by the data reading device 31 and the data accessed by the mass storage disc 35 are decoded by the encoding/decoding module 39 and played by the platform 38.

Besides playing the data accessed by the data reading device 31, the platform 38 also is able to encode the data into a certain data format via the encoding/decoding module 39 and then with the data writing device 33 copy and write into the mass storage disc 35.

Additionally, with the data writing device 33 or the recorder (not shown in the Figures), the platform 38 is able to write the data accessed by the data reading device 31 and by the mass storage disc 35 into the particular format of CD, or write the data accessed by the data reading device 31 into the mass storage disc 35.

Furthermore, via the residential gateway 37, the platform 38 can receive direct-connected or wireless, by LAN or a public wireless telecommunication service, the data from the other network facilities (as network attached storage, on-line computer or IP phone) and then play or write into the mass storage disc 35 with the data writing device 33; again, via the residential gateway 37, the data accessed by the data reading device 31 and by the mass storage disc 35 can be transmitted, direct-connected or wirelessly, to the other network facilities.

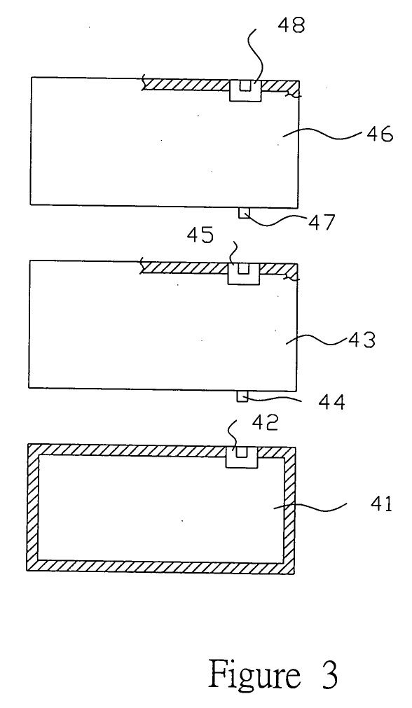

FIG. 3 is the diagram of one linkage way of connectors to connect the platform with the stackable boxes described as above. The platform 41 up links with the first female connector 42; the first stackable box 43 down links with the first male connector 44 and up links with the second female connector 45; the second stackable box 46 down links with the second male connector 47 and up links with the third female connector 48. The first female connector 42 linking with the first male connector 44 and the second female connector 45 linking with the second male connector 47 completes the linkage of the platform 41, the first stack box 43 and the second stack box 46.

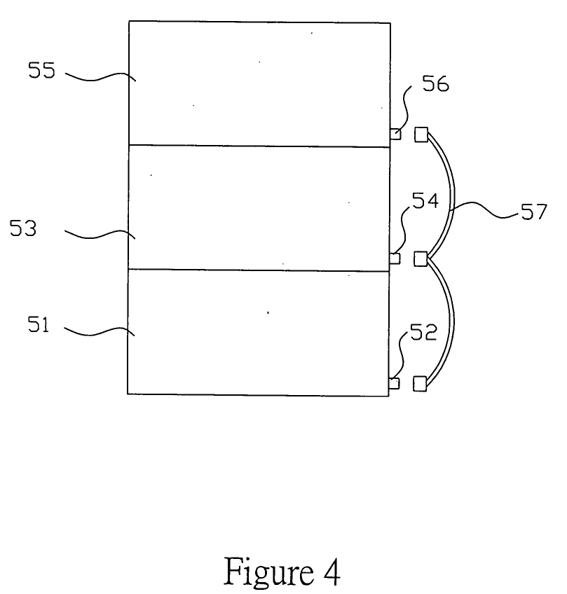

FIG. 4 is the diagram of another linkage way to connect the platform with the stack boxes described as above. One side of the platform 51 links with the first male connector 52; one side of the first stack box 53 links with the second male connector 54; one side of the second stack box 55 links with the third male connector 56; the first, second and third male connectors being linked together by a cable with multiple female connectors 57 completes the linkage of the platform and several stack boxes.

To sum up what stated above, the present invention proposes that several stack boxes can be piled up together in order to access data from the various sources, to simultaneously process the data and to write back in; the present invention also proposes that, besides the way to pile up the stack boxes and to get connected with the platform, the data read/write device also can be accessed through the common industrial transmission standards (as the interfaces of USB, IEEE 1394, IDE, SCSI, 802.3 or 802.11b) to get connected with the platform.

Moreover, the present invention proposes that, in accord to the switch of the different data read/write device, the encoding/decoding module can be filled in with the different one, even can be copied with the different encoding/decoding programs upon requirements. Hence, the superior exemplary implementation of the present invention includes: a data read/write device: to read the data stored in CD or to write according to the certain format; a stackable box: to hold the data read/write device; a playing platform: to cradle the stackable box or to carry several stackable boxes and to connect with the read/write device further to play the data accessed by the data read/write device; an encoding/decoding module: to provide the encoding/decoding programs required by the data read/write device. Besides playing the data accessed by the read/write device, by utilizing the read/write device, the platform can also copy the data and write into the specific CD or storage media.

Although preferred embodiments of the present invention have been described in the forgoing description and illustrated in the accompanying drawings, it will be understood that the invention is not limited to the embodiments disclosed, but is capable of numerous rearrangements, modifications, and substituting of parts and elements without departing from the spirit and scope of the invention. Accordingly, the present invention is intended to encompass such rearrangements, modifications, and substitutions of parts and elements as fall within the scope of the appended claims.

1. An apparatus for retrieving media information from a stackable drive comprising:
a stackable box;
a signal import and export device installed in said stackable box;
a playing platform for said stackable box piled on the top of said playing platform; and
a decoding module connecting to and positioned inside said playing platform for being able to export said media information to a display facility.

2. The apparatus of claim 1, wherein said signal import and export device is an optical reading and writing device.

3. The apparatus of claim 2, wherein said optical reading and writing device is a DVD writable drive.

4. The apparatus of claim 1, wherein said decoding module is a MPEG decoder.

5. The apparatus of claim 1, wherein said display facility is a television.

6. The apparatus of claim 1, wherein said media information accessed by said optical reading and writing device is stored in a storage device.

7. The apparatus of claim 6, wherein said media information contained in said storage device is transmitted to and recorded in an optical disk by said optical reading and writing device.

8. The apparatus of claim 1, wherein a hard disc drive is connected to and positioned inside said stackable box.

9. An apparatus for retrieving media information from a stackable drive comprising:
a data reading and writing drive to read and write said media information stored in an optical disk;
a stackable box for holding said data reading and writing drive;
a player for carrying said stackable box, connected to said data reading and writing drive for playing said media information accessed by said data reading and writing drive; and
an encoding/decoding module for providing an encoding/decoding program required by said data reading and writing drive.

10. The apparatus of claim 9, wherein said data reading and writing drive is a data writing device accompanying with said encoding/decoding program provided by said encoding/decoding module, for encoding said media information into a data format and further to write into a CD.

11. The apparatus of claim 9, wherein said data reading and writing drive is a DVD rewritable device.

12. The apparatus of claim 9, wherein said stackable box is piled up on the top of said player.

13. The apparatus of claim 9, wherein plurality of said stackable box are piled up together on the top of said player, one by one, in order to access data from the various sources and to simultaneously process said media information and further to play and to write back in.

14. The apparatus of claim 9, wherein said stackable box connects to said player via an industrial transmission connector and protocol.

15. The apparatus of claim 14, wherein said industrial transmission connector and protocol is a I-1394 connector and protocol.

16. The apparatus of claim 14, wherein said industrial transmission connector and protocol is a USB connector and protocol.
